(19) United States
(12) Patent Application Publication
(10) Pub. No.: US 2008/0263943 A1
(43) Pub. Date: Oct. 30, 2008

(54) Coordinated Flat Talkers and Plant Tags and Method of Communicating Pertinent Plant Criteria

(76) Inventor: Werner Sperzel, Brookfield, WI (US)

Correspondence Address: WHYTE HIRSCHBOECK DUDEK S C, 555 EAST WELLS STREET, SUITE 1900, MILWAUKEE, WI, 53202, US

(21) Appl. No.: 11/741,559

(22) Filed: Apr. 27, 2007

(51) Int. Cl. A01G 9/02

(52) U.S. Cl. 47/66.6

(57) ABSTRACT

A combination of a plant flat having a plant talker, and plant containers in the flat having plant tags, wherein the talkers and tags coordinate with respect to the conveyance of particular plant criteria or other useful information to the purchaser. Such criteria may include desired planting conditions, including sunlight, part sunlight, shade, part shade, moisture needs, drainage needs, soil content and soil pH or plant features such as the capability of plants to attract butterflies or hummingbirds, plant color or fragrance. The invention also provides for a method of communicating information about plants through the use of the coordinated talkers and tags.

### FIELD OF THE INVENTION

In general, the inventive arrangements relate to the combination of coordinated flat talkers and plant tags to convey information and the method of communicating pertinent plant characteristics to workers and purchasers at retail centers through the use of coordinated talkers and tags.

### BACKGROUND OF THE INVENTION

The invention relates to the combination of plant tags and flat “talkers,” that “echo” each other as to pertinent plant characteristics, as well as a method of coordinating tags and talkers, on plant flats and individual plant containers that fit within these flats sold in retail centers in order to convey useful and pertinent information about the plants sold therein.

Many gardeners plant annual bedding plants every year to add color and attractiveness to their yard during the spring, summer and fall months. During these months, much time is spent outdoors and a colorful and fragrant garden provides an attractive setting for entertaining and for enjoying the outdoors. Gardeners also add perennial plants to their gardens on a regular basis.

A significant problem encountered by purchasers when shopping for plants in retail centers is in determining which plants may be appropriate in a particular location in their yard or on their patio or deck. It is well known that different plants will thrive in different sun, moisture and soil conditions. For example, some plants thrive in the shade, or part shade, whereas other plants require full, or mostly full, sunshine. Some plants may require certain soil conditions to thrive involving moisture conditions, drainage conditions or pH of the soil (acidity or baseness). Other criteria that could be important in making plant choices could involve fragrance, color, or whether hummingbirds or butterflies are attracted to any particular plants or flowers.

It is a significant problem for the novice gardener to invest a considerable amount of money on garden displays, only to find that the chosen plants have been planted in unacceptable conditions under which they do not thrive or even die. Not only is substantial expense required to purchase replacement plants, but also, substantial physical work in replanting.

Oftentimes, customers may be overwhelmed when entering a retail establishment with the wide array of plant varieties and must rely on employees or guide books to assist them in making decisions as to which plants are appropriate for a particular location in his or her yard. This method of choosing plants can be frustrating and time consuming for both customers and employees and can result in dissatisfied customers if choices are made incorrectly and the selected plants do not thrive in the desired location.

Furthermore, employees, who may or may not be well versed in the particular characteristics of all of the plant varieties available at their stores may have difficulty guiding customers to a correct choice. They may also have difficulty grouping certain plants together based on common criteria or in placing them in the proper location if they have been moved by customers out of their original sales location.

It is desirable to provide a flat talker—plant tag combination that “echo” each other in communicating particular plant criteria, such as lighting conditions, moisture conditions, soil conditions (including soil type, content, pH or drainage conditions), attraction of butterflies or hummingbirds to the plants, plant color or fragrance. It is also desirable to have an easy means of communicating to both store personnel and the purchasing public the appropriate conditions or criteria pertinent to planting a particular variety or species.

It is also advantageous to provide a method which coordinates markers on particular plants with a marker for an entire flat, so that retail workers and purchasers can coordinate individual plants of different species with the same criteria in a single flat to facilitate the purchase of appropriate plants.

It is also advantageous for the purchaser, who may wish to mix varieties for the same garden bed, to be able to match plant tags with the flat talkers to ensure and facilitate the purchase of an appropriate variety of plants that will all meet the desired criteria.

### SUMMARY OF THE INVENTION

It is an object of the invention to provide individual plant tags and flat talkers that are coordinated in providing plant information.

It is also an object of the invention to provide plant tags and flat talkers which are coordinated based on particular planting conditions or objectives pertinent to the plants within the plant containers and flats.

It is a further object of the invention to facilitate communication about plant characteristics important to the purchase.

It is another object of the invention to provide plant tags and talkers that echo one another as to particular plant criteria in order to facilitate the grouping of several plant varieties sharing the same criteria.

It is a further object of the invention to provide an easy method of conveying important plant characteristics to workers at retail centers and purchasers of plants to enhance successful choosing and planting of the selected varieties in proper conditions.

### BRIEF DESCRIPTION OF THE DRAWINGS

Preferred embodiments of the invention are described below with reference to the following drawings, which are provided for illustrative purposes only. The drawings illustrate a best mode contemplated for carrying out the invention. In the drawings:

FIG. 1 is a perspective view of a plant flat showing the flat talker inserted in the front of the flat and plant tags inserted in individual plant containers in the flat;

FIG. 2 is a front view of the flat talker shown in FIG. 1, communicating “full sun/part sun” as an appropriate planting criteria;

FIG. 3 is a front view of another embodiment of a flat talker communicating “shade/part shade” as a planting criteria;

FIG. 4 is a front view of the plant tag shown in FIG. 1 with the top portion communicating “full sun/part sun” as a criteria and with the bottom portion of the tag having the name of the plant and a picture of the plant; and

FIG. 5 is front view of another embodiment of a plant tag with the top portion communicating “shade/part shade” as a plant criteria and with the bottom portion of the tag having the name of the plant and a picture of the plant.

Before explaining embodiments of the invention in detail, it is to be understood that the invention is not limited in its application to the details of construction and the arrangement of the components set forth in the following description or illustrated in the drawings. The invention is capable of other embodiments or being practiced or carried out in various ways. Also, it is to be understood that the phraseology and terminology employed herein is for the purpose of description and should not be regarded as limiting.

### DETAILED DESCRIPTION OF THE PREFERRED EMBODIMENT

In a retail center, individual bedding plants and often perennials are typically rooted in soil in small plastic plant containers that are then inserted in larger plant flats. These flats are often designed to hold fifty-four individual plant containers, although the optimum size of both flat and individual plant containers can vary. The individual plant containers are designed to fit snuggly in the flat for easy carrying and transport. Typically, the plants may be sold individually or by a price per flat, based on type and size of the plants.

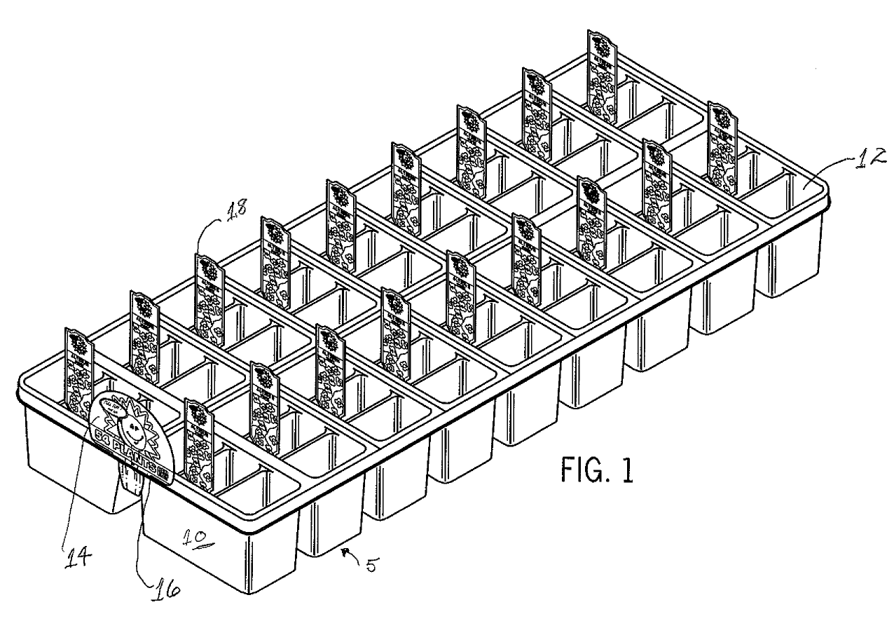

The invention 5 includes a flat 10, more than one plant container 12 inserted therein and information displays on flat talkers 14 and plant tags 18 coordinated between the flat 10 and the container 12. A flat 10 is generally designed to hold multiple individual plant containers 12, each sized to be received in the recesses of the flat 10 as generally shown in FIG. 1. In a preferred embodiment, the invention includes a flat plant tag (known as a “talker”) 14 that, in a preferred embodiment, is inserted into a slit 16 in the front of the plant flat 10. However, there are a variety of means of attaching the talker 14 to the flat 10 and all such means are intended to be included herein. The invention also includes individual plant tags 18 inserted in the plant containers 12 for the purpose of conveying pertinent information about the plants being sold to the prospective purchaser. Flats 10 and the individual plant containers 12 are generally manufactured of plastic but could be made of other materials.

In a preferred embodiment, the talkers 14 and tags 18 are coordinated to convey pertinent information about the plants in the flat 10 and container 12 that would be useful to the purchaser of the plant in making the choice of a particular plant or plants for particular conditions relating to the prospective location of the plant in the purchaser's yard, deck or patio. This does not mean that all of the information appearing on the coordinated talker 14 and tag 18 is identical in all respects. The tags 18, for example, typically will also bear the common and/or Latin name of the specific plant sold in the plant container 12, as well as, a picture of the plant, height and ideal spacing between plants. However, in a preferred embodiment, the talker 14 and tag 18 are coordinated in design and in language with respect to the particular chosen criteria and therefore are readily viewed as a similar and related to one another.

Pertinent criteria conveyed through the coordinated talker 14 and tags 18 could include sun or shade conditions, soil moisture requirements, drought resistance, fragrance, color, soil condition requirements such as drainage and pH requirements, as well as whether the plants tend to attract butterflies or hummingbirds.

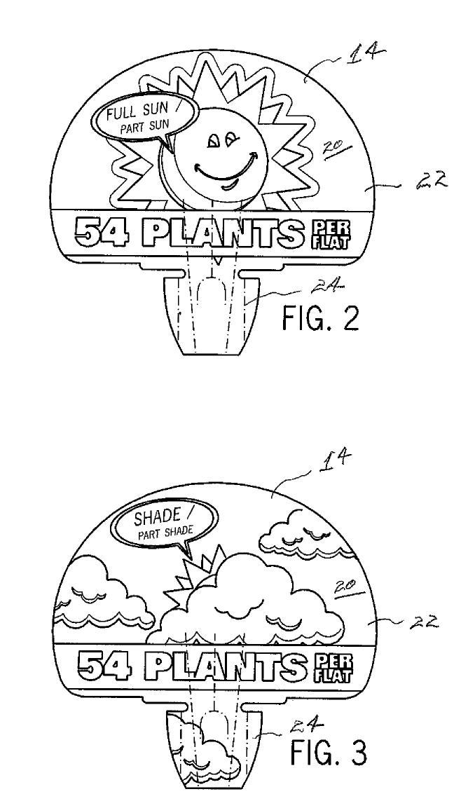

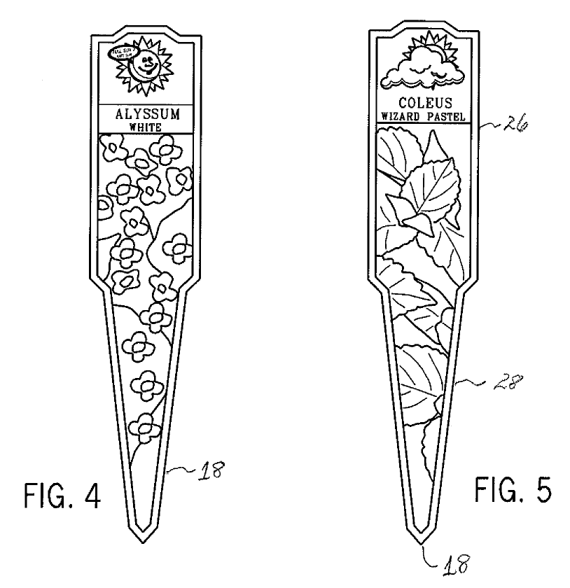

FIGS. 2 and 3 are representative of talkers 14. The talkers 14 shown, convey the optimal sun or shade conditions for the plants. The manner in which such information is conveyed is easily identifiable through the use of pictures and words on the flat front of surface 20 of the talker 14. In a preferred embodiment, the talker 14 has visible upper surface 22 for communicating information and a lower stem 24 for removably affixing the talker 14 into the flat 10. Likewise, the individual plant tags 18, representative embodiments of which are shown in FIGS. 4 and 5, each have an upper portion 26 for communicating information and a lower portion 28 that hold the tag 18 in place in the soil of the plant container 12. Although the talkers 14 and tags 18 shown in the preferred embodiment are flat and preferably manufactured of plastic, they could be manufactured in a variety of shapes and sizes, in a more three dimensional form, having greater depth than the flat embodiment shown, and of different materials if desired.

Regardless of the particular shape and size of the talkers 14 and tags 18, the talkers 14 and tags 18 echo one another in the conveyance of plant criteria so that workers and customers can readily identify which individual plant containers 12 pertain to which flat 10 based on the chosen criteria. This communication concerning the chosen criteria will be typically over and above the pictures and plant names usually found on plant tags 18 currently. On the reverse side of the talker 14 and tags 18, more detailed information may be provided as desired about the plants or criteria.

The coordination of talkers 14 and tags 18 immediately identifies for the consumer and store employees which plants are similar to one another from the standpoint of certain conditions identified on the coordinated talkers 14 and tags 18. In the examples provided, lighting conditions are conveyed as criteria. However, other conditions could be water or soil requirements, including moisture or pH of soil desired, as well as drought tolerance or winter hardiness. Other criteria include whether the plants are attractive to butterflies or hummingbirds. Other conditions that could be conveyed and coordinated through the invention could be color or whether the plant is aromatic. Furthermore, the talker 14 and tag 18 could echo a single criteria or multiple criteria, depending on the desires of the retail center.

Typically in the industry, neither flat 10 nor talker 14 convey any kind of identifying information at all, or they contain a different message than that conveyed by the plant tag 18. The echoing of the plant talker 14 with the tags 18 makes the plants easily identifiable as to a particular criteria, so that different species may be coordinated easily for the same garden conditions. At a glance, both store employees and customers can determine the particular attributes of the plants and bring together different varieties or species having the same ability to thrive in a common location or having other similar desirable attributes. In a preferred embodiment, the flat talker 14 and plant tags 18 have illustrative pictures which readily convey to the observer the particular criteria on which the talker 14 and tags 18 are focused.

The invention furthermore assists employees in grouping certain plant varieties together based on common criteria. For example, with the use of the invention, “full sun” varieties could be grouped together in a greenhouse for the convenience of the purchaser who needs bedding plants for a sun-exposed bed. Similarly, a “Butterfly Garden” grouping could be created to make it easier for customer to make plant choices. Under such circumstances, additional coordinating signage could be used to facilitate the coordinated message and criteria, such as the use of coordinated banners on a table or greenhouse display.

Furthermore, such groupings make it easier for the customer to mix and match different plant varieties and plant containers 12 in a single flat 14 that meet the same criteria. This is particularly useful where a customer may desire a smaller number of plants than fifty-four (a common number of plants in a single flat 14) of a single variety.

The invention also includes an improved method of communicating pertinent plant information by coordinating images and language that readily convey chosen plant criteria on both flat talkers 14 and plant tags 18. Additional information, such as the particular plant variety or name, may be communicated on the tag 18 only. However, the “echoing” of the desired plant criteria on both flat talkers 14 and tags 18 readily conveys the critical information and cross-varietial information about characteristics that different varieties may have in common, thereby facilitating the combination of varieties based on the criteria in a common garden bed.

In a preferred embodiment, the method would consist of creating a combination of visual design and/or language that readily conveys the desired criteria; coordinating the significant features of the combination on both flat talkers 14 and tags 18; and removably attaching the talker 14 bearing the criteria to the flat 10 and the coordinating tag 18 to the individual plant container 12.

It is understood that the various preferred embodiments are shown and described above to illustrate different possible features in the invention and the varying ways these features may be combined. Apart from combining the different features of the above embodiments and varying ways, other modifications are also considered to be within the scope of the invention.

The invention is not intended to be limited to the preferred embodiments described above, but rather is intended to be limited only by the claims setout below Thus, the invention encompasses all alternate embodiments that fall literally or equivalently within the scope of these claims.

What is claimed is:

1. A plant flat;
at least two plant containers seated within the flat;
a plant talker associated with the flat; and
at least one plant tag inserted in at least one of the plant containers;
wherein the talker and the tag convey coordinated information about plant criteria.

2. The invention of claim 1, wherein the talker and tags are removably affixed.

3. The invention of claim 2, wherein the flat has a slit thereon to receive the talker.

4. The invention of claim 1, wherein the talker is affixed to the flat.

5. The combination of claim 1, wherein the criteria may be desirable planting conditions, including sunlight, part sunlight, shade, part shade, moisture needs, drainage needs, soil content or soil pH.

6. The combination of claim 1, wherein the criteria may be certain plant features including the capability of attracting butterflies, capability of attracting hummingbirds, color or fragrance.

7. The invention described in claim 1, wherein the plant talker and plant tags communicate criteria through the use of pictures;

8. The invention described in claim 1 wherein the plant talker and plant tags communicate criteria through a combination of words and illustrations.

9. The invention described in claim 1, wherein the plant talker and plant tags provide information on more than one criteria.

10. A method of communicating information about plants by taking the following steps:
a. In a plant flat containing multiple individual plant containers each containing a plant, a talker communicating pertinent plant information is inserted in the flat;
b. At least one tag is inserted in an individual plant container; and
c. The talker and tag are coordinated in design and language to communicate plant criteria.

11. A method of echoing information between plant containers having multiple plants and individual plant containers through the use of coordinating tags notifying prospective purchasers of chosen criteria relative to the plants in both multiple containers and individual containers.

12. A system of communicating plant criteria to prospective purchasers comprising:
a plant flat having means for communicating information thereon;
at least one plant container fitted within the plant flat having means for communicating information, wherein the communication of the plant container echoes the communication of the plant flat.

13. The system of claim 12, wherein the plant flat and plant container are in a retail center, wherein further means of communicating plant criteria through signage in the retail center is provided and coordinated with the communication of the plant flat and plant container.
